(19) United States
(12) Patent Application Publication
(10) Pub. No.: US 2022/0163860 A1
(43) Pub. Date: May 26, 2022

(54) PI-D CONJUGATED COORDINATION POLYMER FOR ELECTROCHROMIC ENERGY STORAGE

(71) Applicant: NANYANG TECHNOLOGICAL UNIVERSITY, Singapore (SG)

(72) Inventors: Guofa CAI, Singapore (SG); Peng CUI, Singapore (SG); Pooi See LEE, Singapore (SG)

(21) Appl. No.: 17/594,159

(22) PCT Filed: Apr. 6, 2020
(86) PCT No.: PCT/SG2020/050213

§ 371 Date: Oct. 4, 2021

(30) Foreign Application Priority Data
Apr. 4, 2019 (SG) 10201903037R

(51) Int. Cl. G02F 1/155; G02F 1/1516; G02F 1/1524; H01G 11/48; H01G 11/86; H01M 4/04; H01M 4/60

(52) U.S. Cl. CPC G02F 1/155; G02F 1/15165; G02F 1/1524; H01M 4/602; H01G 11/86; H01M 4/0404; H01G 11/48

(57) ABSTRACT

An electrochromic energy storage device disclosed herein comprises a first electrode and a second electrode disposed in an electrolyte, wherein the first electrode comprises a coordination polymer, wherein the coordination polymer comprises a transition metal and a tetradentate ligand conjugated to the transition metal, wherein the transition metal and the tetradentate ligand render the first electrode operable to (i) store electrical energy and at the same time change its optical state upon electrical charging of the electrochromic energy storage device, and (ii) release electrical energy stored therein and at the same time change its optical state upon electrical discharge of the electrochromic energy storage device. A method of forming the electrochromic energy storage device and a method of forming an electrochromic energy storage film are disclosed herein. In a preferred embodiment, the first electrode is prepared by growing one dimensional π-d conjugated coordination polymer nanowires film comprising metallic nickel nodes and organic linkers of 1,2,4,5-benzenetetramine (BTA) on a transparent fluorine-doped tin oxide (FTO) conducting substrate.

### CROSS-REFERENCE TO RELATED APPLICATION

This application claims the benefit of priority of Singapore Patent Application No. 10201903037R, filed 4 Apr. 2019, the content of it being hereby incorporated by reference in its entirety for all purposes.

### TECHNICAL FIELD

The present disclosure relates to an electrochromic energy storage device and its method of production.

### BACKGROUND

Electrochromic devices may be deemed as an energy saving technology for use in smart window displays, anti-glare mirrors, etc., due to their aesthetic glazing, excellent dynamic control, and good coloration memory effect. The coloration memory effect may refer to a situation where the optical properties remain the same for an extended period of time without a charge insertion to the device for maintaining the optical properties.

For instance, reports have shown that buildings installed with smart windows may reduce energy consumption for cooling, heating, and lighting, by as much as 40%. In another instance, the dynamic coloration control provided by electrochromic smart windows may protect users' privacy, and offer a comfortable or an aesthetic environment for occupants in buildings installed with such smart windows.

To maximise the utilization of space in buildings, research may have been increasingly focused on integrating features and multifunctionalities into electrochromic smart windows, one of which may be integration of energy storage and/or energy harvesting functionalities in electrochromic smart window. However, improvements in energy density, coulombic efficiency, cycling and rate capability may be needed for such multifunctional electrochromic smart windows to be practically usable.

Electrochromic and energy storage functionalities may be rendered from electrochemical redox reactions, which may in turn be highly related to the surface area and electrical conductivity of active materials used in the electrochromic devices. Active materials widely studied for use as electrode materials in electrochromic devices to improve surface area and electrical conductivity, include metal oxide nanomaterials (e.g. NiO, V₂O₅, WO₃, MoO₃) and conducting polymers (e.g. polyaniline), respectively. On the other hand, the energy storage functionality may depend on development of high energy density electrochromic materials, which tends to be governed by the need for large optical transmittance. In other words, all of these properties (e.g. higher surface area, better electrical conductivity, higher energy density) may be difficult to achieve concurrently in a single material. Thus, some efforts were channeled to developing electrochemical active materials that have high surface area and electrical conductivity for better integration of electrochromic and energy storage properties. In this connection, band gap engineering was considered in the design of materials for energy storage and electrochromic devices, which affected capacity, coulombic efficiency, redox potential, stability, optical transparency, etc. One of the materials investigated includes coordination polymers (CPs).

CPs may consist of metal ions or clusters coordinated with organic linkers to form one, two, or three dimensional structures, and may be known to have high porosities, surface areas, tunable structures and compositions. Taking advantage of such properties and their versatility in structure design at the molecular level, CPs may be promising candidates for electrochromic and/or energy storage materials. That said, CPs may have poor electrical conductivity that significantly limits utilization of built-in redox centres, resulting in large polarization of redox peaks, small optical modulation, low capacity and rate capability, poor electrochemical stability, etc. For instance, electrically conductive and electrochemically stable CPs have been designed and synthesized for use as an electrochemical double layer capacitor (EDLC) and pseudocapacitor. A moderate gravimetric capacity of about 30 mAh g⁻¹ and volumetric capacity of about 32 mAh cm⁻³ were achieved by the EDLC, while higher gravimetric (59.3 mAh g¹) and volumetric (105.5 mAh cm⁻³) capacities may be realized by the pseudocapacitor. These energy storage performances may be comparable or better than porous carbon electrodes, but remain inferior to other existing energy storage materials. Moreover, there may be no or a lack of CPs having a desirable level of both electrochromic and energy storage properties.

There is thus a need to provide for a solution that addresses one or more of the limitations mentioned above. The solution should at least provide for a CP that is electrochromic and has charge storage ability.

In a first aspect, there is provided for an electrochromic energy storage device comprising:

a first electrode and a second electrode disposed in an electrolyte;

wherein the first electrode comprises a coordination polymer, wherein the coordination polymer comprises a transition metal and a tetradentate ligand conjugated to the transition metal, wherein the transition metal and the tetradentate ligand render the first electrode operable to:

(i) store electrical energy and at the same time change from a first optical state to a second optical state upon electrical charging of the electrochromic energy storage device, and

(ii) release electrical energy stored therein and at the same time change from the second optical state to the first optical state upon electrical discharge of the electrochromic energy storage device.

In another aspect, there is provided for a method of forming the electrochromic energy storage device described in various embodiments of the first aspect, the method comprising:

contacting a substrate with an aqueous solution comprising a transition metal precursor and a tetradentate ligand precursor;

adding a base to the aqueous solution in the presence of the substrate to form the first electrode; and

electrically connecting the first electrode to the second electrode to form the electrochromic energy storage device.

In another aspect, there is provided for a method of forming an electrochromic energy storage film, the method comprising:

contacting a substrate with an aqueous solution comprising a transition metal precursor and a tetradentate ligand precursor; and

adding a base to the aqueous solution in the presence of the substrate to form the electrochromic energy storage film.

### BRIEF DESCRIPTION OF THE DRAWINGS

The drawings are not necessarily to scale, emphasis instead generally being placed upon illustrating the principles of the invention. In the following description, various embodiments of the present disclosure are described with reference to the following drawings, in which:

FIG. 1A shows a synthesis scheme of the nickel 1,2,4,5-benzenetetramine (NiBTA) conjugated coordination polymer disclosed herein.

FIG. 1B is a scanning electron microscope (SEM) image showing a Lop-down view of the NiBTA film on fluorine-doped tin oxide (FTO) glass. Scale bar denotes 1 μm. The inset is a SEM image showing the cross-section of the NIBTA film on FTO glass. Scale bar denotes 100 nm.

FIG. 1C is a transmission electron microscope (TEM) image of a NiBTA nanowire. Scale bar denotes 500 nm. The inset shows the high magnification TEM image of the NiBTA nanowire. Scale bar of inset denotes 5 μm.

FIG. 1D is a plot of the experimental and simulated x-ray powder diffraction (XRD) patterns of NiBTA nanowire powder.

FIG. 1E is a plot of the x-ray pair distribution function (XPDF) of the NiBTA nanowire powder.

FIG. 1F is an atomic force microscope (AFM) image showing the top view of the NiBTA nanowires film on FTO glass.

FIG. 1G shows the corresponding three dimensional AFM image of the NiBTA nanowires film on FTO glass referred to in FIG. 1F.

FIG. 1H is a high magnification SEM image of the NiBTA nanowire in FIG. 1B. The scale bar denotes 100 nm.

FIG. 2A is a SEM image of the NiBTA nanowires film on a nickel foam. Scale bar denotes 10 μm.

FIG. 2B is a SEM image of the NiBTA nanowires film on a nickel foam. Scale bar denotes 100 nm.

FIG. 2C is a SEM image of the NiBTA nanowires film on a carbon fiber. Scale bar denotes 1 μm.

FIG. 2D is a SEM image of the NiBTA nanowires film on a carbon fiber. Scale bar denotes 100 nm.

FIG. 2E is a SEM image of the NiBTA nanowires film on a normal cloth. Scale bar denotes 1 μm.

FIG. 2F is a SEM image of the NiBTA nanowires film on a normal cloth. Scale bar denotes 100 nm.

FIG. 2G shows the x-ray photoelectron spectroscopy (XPS) survey spectra of the NiBTA nanowires film on FTO glass.

FIG. 2H shows the x-ray photoelectron spectroscopy (XPS) narrow scans Ni₂ₚ core-level spectra of the NiBTA nanowires film on FTO glass.

FIG. 2I shows the x-ray photoelectron spectroscopy (XPS) highly resolved N₁ₛ spectra of the NiBTA nanowires film on FTO glass.

FIG. 3 shows the x-ray pair distribution function (XPDF) for fresh NiBTA nanowires and a sample exposed to air for 2 months.

FIG. 4 shows the thermogravimetric analysis (TGA) curve of the NiBTA nanowires.

FIG. 5A shows the N₂ adsorption isotherm of the NiBTA nanowires.

FIG. 5B is a plot of the pore size distribution of the NiBTA nanowires.

FIG. 6A shows the electronic absorption spectroscopy of NiBTA nanowires.

FIG. 6B is a plot of the electrical conductivity variation with respect to temperature. The inset is a photograph of the NiBTA nanowires pellet after sputtering gold electrodes synmetrically on the edges.

FIG. 7A shows the cyclic voltammogram and in situ transmittance at 500 nm for the present NiBTA nanowires film in 1 M KOH electrolyte at a scan rate of 10 mV s⁻¹ in the potential range of 0-0.6 V vs. Ag/AgCl.

FIG. 7B shows the transmittance spectra of the present NiBTA nanowires film in the initial, bleached (0 V vs. Ag/AgCl) and colored (0.6 V vs. Ag/AgCl) states between the wavelength region of 300 and 1100 nm.

FIG. 7C shows photographs of the present NiBTA nanowires film in the initial, bleached and colored states.

FIG. 7D shows solar irradiance spectra converted from the measured transmittance spectra of the present NiBTA CP film.

FIG. 7E shows the in situ optical responses for the present NiBTA nanowires film (having a size of 4 cm²) under the applied potential square-wave of 0 and 0.6 V vs. Ag/AgCl for 60 s per step test at 500 nm.

FIG. 7F is a plot of optical density as a function of the charge density during coloring process of the present NiBTA nanowires film (having a size of 4 cm²) at 500 nm, wherein the slope obtained is 223.6 cm² C⁻¹. In this instance, switching speeds t_{c} and t_{b} happen to be 1.8 s and 5 s, respectively.

FIG. 7G shows the cyclic voltammograms of present NiBTA nanowires film in 1 M KOH electrolyte at different scan rates from 5 to 100 mV s⁻¹ in the potential range of 0 to 0.6 V vs. Ag/AgCl. The current density in the CV curves has already been normalized.

FIG. 7H shows the 1^{st} to 6^{th} cyclic voltammograms of NiBTA nanowires film in 1 M KOH electrolyte at 5 mV s⁻¹ (left plot) and 10 mV s⁻¹ (right plot), both in the potential range of 0-0.6 V vs. Ag/AgCl.

FIG. 7I shows the in situ optical responses under the applied potential square-wave of 0 and 0.6 V vs. Ag/AgCl for the present NiBTA nanowires film (having a size of 25 cm²) for 60 s per step test at 500 nm.

FIG. 7J is a plot of optical density as a function of the charge density during bleaching process of the present NiBTA nanowires film used for FIG. 7I at 500 nm, wherein the slope obtained is −179.7 cm² C⁻¹. In this instance, t_{c} and t_{b} happen to be 34.9 s and 34.6 s, respectively.

FIG. 8A shows the potential square-wave applied to the present NiBTA nanowires film (having a size of 4 cm²) on FTO glass between 0 and 0.6 V vs. Ag/AgCl.

FIG. 8B is a plot of the corresponding current response of the present NiBTA nanowires film on FTC glass of FIG. 8A when potential was switched between 0 and 0.6 V vs. Ag/AgCl.

FIG. 8C is a plot of optical density as a function of the charge density during coloring of the present NiBTA nanowires film (having a size of 25 cm²) at 500 nm, wherein the slope obtained is 53.8 cm²C⁻¹. In this instance, t_{c} and t_{b} happen to be 34.9 s and 34.6 s, respectively.

FIG. 8D shows the transmittance change of the present NiBTA nanowires film at 500 nm after colored and then having the power turned off (under open circuit). The results plotted in FIG. 8D may be independent of the sample size.

FIG. 9A shows the cycle performance of the present NiBTA nanowires film used for FIG. 8A measured in 1 M KOH for 10000 cycles.

FIG. 9B shows the potential square-wave applied to the present NiBTA nanowires film (having a size of 25 cm²) on FTO glass between 0 and 0.6 V vs. Ag/AgCl.

FIG. 9C is a plot of the corresponding current response of the present NiBTA nanowires film (having a size of 25 cm²) on FTO glass used for FIG. 9B when potential was switched between 0 and 0.6 V vs. Ag/AgCl.

FIG. 10A shows galvanostatic charge/discharge profiles for the present NiBTA nanowires film under different currents density in the potential range of 0 to 0.5 V vs. Ag/AgCl (ranging from 1.7 to 16.7 A g⁻¹).

FIG. 10B shows the gravimetric capacity of the present NiBTA nanowires film as a function of the current density.

FIG. 10C is a plot of the galvanostatic charge/discharge curve of the present NiBTA nanowires film at a current density of 1.7 A g⁻¹ and the corresponding optical responses spectra at 500 nm.

FIG. 10D shows the transmittance spectra of the present NiBTA CP film after 10000 charge/discharge cycles (between 0 and 0.5 V).

FIG. 11A is a plot of the volumetric capacity of the present NiBTA nanowires film as a function of the current density.

FIG. 11B is a plot of the areal capacity of the present NiBTA nanowires film as a function of the current density.

FIG. 11C is a gravimetric Ragone plot (power density against energy density) of the present NiBTA nanowires film.

FIG. 11D is a volumetric Ragone plot (power density against energy density) of the present NiBTA nanowires film.

FIG. 12A is a plot of the galvanostatic charge/discharge curve of the present NiBTA nanowires film on FTO glass at a current density of 4.2 A g⁻¹ and the corresponding optical responses spectra at 500 nm.

FIG. 12B is a plot of the galvanostatic charge/discharge curve of the present NiBTA nanowires film on FTO glass at a current density of 8.3 A g⁻¹ and the corresponding optical responses spectra at 500 nm.

FIG. 13 is a plot of the electrochemical stability and coulombic efficiency of the present NiBTA nanowires film on FTO glass measured over a long term cycling of 10000 galvanostatic charge/discharge cycles at a current density of 12.5 A g⁻¹.

FIG. 14 is a table showing the performance of conventional electrochromic and energy storage materials. The term “Non.” in FIG. 14 refers to data not obtainable.

FIG. 15A shows Nyquist plots of the present NiBTA nanowires film after subjected to 1, 1000, 5000 and 10000 cycles.

FIG. 15B shows the corresponding galvanostatic charge/discharge curves of the present NiBTA nanowires film of FIG. 15A after subjected to 1, 1000, 5000 and 10000 cycles.

FIG. 16A shows the configuration of a solid-state device assembled using the present NiBTA nanowires film as the electrochromic layer, sprayed TiO₂ nanoparticles film as the ion storage layer, and KOH/PVA as the solid electrolyte.

FIG. 16B is a transmittance spectra of the solid-state device of FIG. 16A in the initial, bleached and colored states between the wavelength region of 300 and 900 nm.

FIG. 16C shows the current response of the solid-state device of FIG. 16A when a voltage range of between 0 and 1.5 V is applied for 30 seconds per step.

FIG. 16D shows the corresponding in situ transmittance response for 30 seconds per step measured at 500 nm for the solid-state device of FIG. 16A.

FIG. 16E shows the optical density as a function of the charge density during coloring process at 500 nm for the solid-state device of FIG. 16A, wherein the slope obtained is 148 cm² C⁻¹.

FIG. 16F shows the transmittance changes at 500 nm for the solid-state device of FIG. 16A in the colored and bleached states after power off for 2400 s.

FIG. 17 shows a cyclic voltammogram at 10 mV s⁻¹ of a solid-state device assembled using the present NiBTA nanowires film as the electrochromic layer, sprayed TiO₂ film as the ion storage layer, and KOH/polyvinyl alcohol (PVA) as the solid electrolyte.

### DETAILED DESCRIPTION

The following detailed description refers to the accompanying drawings that show, by way of illustration, specific details and embodiments in which the invention may be practised.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

The present disclosure relates to an electrochromic device that may selectively modulate the transmittance of electromagnetic waves (e.g. ultraviolet waves, visible light and infrared) based on electrical charging and discharging of the electrochromic device. Advantageously, at the same time, the electrochromic device may store electrical energy and/or release the electrical energy stored, respectively. The electrochromic device may change its optical state, e.g. its color, based on the electrical charging and discharging, rendering the device capable of modulating its transmittance of electromagnetic waves. The change in optical state, such as its color, may correspond to electrical energy, e.g. electrical charges, stored or released therefrom, and this provides for an indication of the electrical energy stored in the device. Hence, the electrochromic device may be termed herein an electrochromic energy storage device, which may serve as an energy storage indicator.

The present electrochromic energy storage device may comprise a coordination polymer (CP). The coordination polymer of the present electrochromic energy storage device may be formed of repeating entities each having at least one metal ion coordinated (i.e. conjugated) to one or more organic ligands. The metal ion may comprise a transition metal ion. The organic ligands may be referred to herein as “organic linkers”, as the organic ligands link the metal ions together to form the repeating entities. The terms “coordinated” and “conjugated” herein may be used interchangeably, both referring to bonding of an organic ligand with the metal ion. Coordinated polymers of the present disclosure may be distinguished from a metal-organic framework in that a metal-organic framework potentially contains voids in their molecular structure but not the coordinated polymers of the present disclosure. The coordination polymer may form or may be used as an electrode of the electrochromic energy storage device.

Advantageously, the present coordination polymer provides for, simultaneously, the electrochemical-controlled optical and charge storage properties, which have been mentioned above. Said differently, the present coordination polymer may be desirable and useful for fabricating smart devices with both electrochromic and energy storage functions. Compared to metal oxides conventionally adopted for electrochromic windows or energy storage applications, the higher electrical conductivity and larger surface area of the present coordination polymer address the poorer electrical conductivity and smaller surface area of the metal oxides that adversely limit electro-optical modulations and capacitance storage.

The present disclosure also provides for a method of making the electrochromic energy storage device. The method may involve facile synthesis of a one dimensional semiconductive conjugated coordination polymer (i.e. the present coordination polymer) on a substrate.

The resulting coordination polymer may be a thin film comprising nanowires (i.e. nanowires film), which may exhibit superior performances for both electrochromic and energy storage functions. Particularly, the uniform nanowires film may show a tri-state electrochromic phenomenon, large optical modulation up to 61.3% (e.g. at 500 nm), and high gravimetric (168.1 mAh g⁻¹) and volumetric (129.2 mAhc m⁻³) capacities. In addition, the nanowires film can maintain its rechargeability and electrochromic properties even after 10000 electrochemical cycles demonstrating high durability. Advantages of present electrochromic energy storage device, the present coordination polymer and their method of making, and other advantages, are demonstrated in the examples of the present disclosure.

Details of various embodiments of the electrochromic energy storage device, method of forming the electrochromic energy storage device, and method of forming an electrochromic energy storage film usable in the electrochromic energy storage device, and advantages associated with the various embodiments are now described below.

In the present disclosure, there is provided for an electrochromic energy storage device. The electrochromic energy storage may comprise a first electrode and a second electrode disposed in an electrolyte. The first electrode may comprise a coordination polymer. The coordination polymer may comprise a transition metal and a tetradentate ligand conjugated to the transition metal, wherein the transition metal and the tetradentate ligand render the first electrode operable to (i) store electrical energy and at the same time change from a first optical state to a second optical state upon electrical charging of the electrochromic energy storage device, and (ii) release electrical energy stored therein and at the same time change from the second optical state to the first optical state upon electrical discharge of the electrochromic energy storage device.

In various embodiments, the transition metal may comprise nickel, copper, cobalt, or iron. The transition metal may exist as a transition metal ion in the electrochromic energy storage device. The transition metal ion may be a cation. In various embodiments, the transition metal ion may comprise Ni²⁻, Cu²⁺, Co²⁺, or Fe²⁺.

In various embodiments, the tetradentate ligand may comprise or may consist of 1,2,4,5-benzenetetramine. Other ligands that can be conjugated to the transition metal to form a coordination polymer that provides for electrochromic and energy storage capability may be used.

The transition metal and the tetradentate ligand cooperate to provide for both the electrochromic and energy storage capabilities. The transition metal of the coordination polymer at an initial optical state, may have a net charge of zero in the electrochromic energy storage device. When the electrochromic energy storage device gets electrically charged, e.g. applying a voltage to the first electrode, the transition metal may be oxidized to a first oxidation state. When the electrochromic energy storage device gets discharged, e.g. voltage is removed from the first electrode, the transition metal may be reduced to a second oxidation state that is lower than the first oxidation state but higher than the net charge of zero at the initial optical state. Subsequently, the first electrode, and hence the electrochromic energy storage device, may be optically modulated based on the first oxidation state and second oxidation state of the transition metal in the coordination polymer. It is therefore advantageous that both the transition metal and the tetradentate ligand herein cooperate to allow for such modulation of the transition metal between different oxidation states, which in turn controls optical modulation of the first electrode. Said differently, even when the transition metal and tetradentate ligand are conjugated to form the coordination polymer, there is no compromise that results in the transition metal losing its ability to vary its oxidation state.

The term “initial optical state” refers to an optical state of the first electrode that has just been formed. Said differently, the initial optical state of the first electrode includes an optical state of a first electrode that has not even been used. The initial optical state may persist for only a few cycles of electrical charging and discharging. For example, the first electrode may not be operable to have the initial optical state after 5 or more cycles of electrical charging and discharging.

For a better understanding of the optical modulation of the first electrode described above, a non-limiting example of using nickel (Ni) as the transition metal and 1,2,4,5-benzenetetramine (BTA) as the tetradentate ligand is referred to. The coordination polymer comprising nickel and 1,2,4,5-benzenetetramine may be termed herein as NiBTA.

When NiBTA is formed as the first electrode, it may be blue in color. This may represent the initial optical state. In the initial optical state, the first electrode may be opaque to electromagnetic waves of the ultraviolet, visible light and infrared regions. For instance, in the initial optical state, the first electrode may be opaque to electromagnetic waves having a wavelength in the range of 300 nm to 1100 nm. The term “opaque” herein refers to a material that does not allow (i.e. block) a substantial amount of electromagnetic waves to transmit through. For instance, in the initial optical state, the first electrode formed of NiBTA may block at most 60%, 70%, 80%, or 90%, of electromagnetic waves having the wavelength ranging from 300 nm to 1100 nm. As a non-limiting example, 68.3%, 65.9%, and 90.4% of electromagnetic waves at 350 nm, 500 nm and 900 nm may be blocked by the blue NiBTA electrode, respectively.

Upon and/or after a voltage of more than 0 V and up to 0.6 V gets applied, the blue NiBTA electrode turns brown. The brown NiBTA may represent the colored optical state. In the brown NiBTA, the nickel gets oxidized to Ni³⁺. The nickel also interacts with an anion of the electrolyte. For example, where the electrolyte used is potassium hydroxide (KOH), the OH⁻ anion interacts with the Ni³⁺ of the coordination polymer. In this optical state, the brown NiBTA may continue to block ultraviolet and visible light waves, but allow infrared waves to transmit through. For instance, the brown NiBTA may be opaque to (i) at most 70% or 80% of electromagnetic waves having a wavelength ranging from 300 nm to 680 nm, and (ii) at most 40%, 30%, 20%, 15%, 10%, or even 5%, of electromagnetic waves having a wavelength ranging from 680 nm to 1100 nm. As a non-limiting example, 75% and 71.3% of the electromagnetic waves at 350 nm and 500 nm were blocked while only 14.78% of electromagnetic waves at 900 nm was blocked.

Upon and/or after discharging (removal of voltage to 0 V), the brown NiBTA electrode may turn transparent. This may represent the bleached optical state. In the bleached NiBTA, the nickel gets reduced from Ni³⁺ to Ni²⁺. In this optical state, the bleached NiBTA may allow most or all of the ultraviolet, visible light and infrared waves to transmit through. For instance, the bleached NiBTA may be opaque to (i) at most 40%, 30%, 25%, 20%, or even 10%, of electromagnetic waves having a wavelength ranging from 300 nm to 1100 nm. As a non-limiting example, 24.98%, 10.01% and 7.14% of electromagnetic waves at 350 nm, 500 nm and 900 nm were blocked, respectively.

Accordingly, the first electrode, and hence the electrochromic energy storage device, may exhibit the tri-state electrochromic phenomenon, which includes the initial optical state, the colored optical state and the bleached optical state.

While the first electrode may be described in terms of the optical state it operates in, the first electrode may also be described based on the difference in transmittance of two optical states in various embodiments. The difference in transmittance between two optical states may be referred herein to as the optical modulation of the first electrode. The two optical states may be referred to as the first optical state and the second state. The first optical state may be the bleached optical state (transparent state) and the second optical state may be the colored optical state (brown colored state). Accordingly, in various embodiments, the first optical state and the second optical state may exhibit a difference in transmittance ranging from 40% to 60% for electromagnetic waves having a wavelength ranging from 400 nm to 600 nm. In various embodiments, the first optical state and the second optical state may exhibit a difference in transmittance ranging from 20% to 60% for electromagnetic waves having a wavelength ranging from 600 nm to 800 nm. In various embodiments, the first optical state and the second optical state may exhibit a difference in transmittance ranging from 10% to 20% for electromagnetic waves having a wavelength ranging from 800 nm to 1100 nm.

Electromagnetic waves having a wavelength in a range of 10 nm to 380 nm may be part of the ultraviolet spectrum. Electromagnetic waves having a wavelength in a range of 380 nm to 780 nm may be part of the visible light spectrum. Electromagnetic waves having a wavelength in a range of 780 nm to 2.5 μm may be part of the near infrared spectrum.

In various embodiments, the first electrode may comprise a substrate which the coordination polymer may be disposed on. In various embodiments, the coordination polymer may be in the form of nanowires, wherein the nanowires extend substantially perpendicular from a surface of the substrate. The term “substantially perpendicular” herein refers to nanowires arranged at 90°, 80°, or even 70°, from the surface of the substrate.

In various embodiments, the substrate used in the electrode may be electrically conductive. In various embodiments, the substrate may be a foam material. The substrate may comprise a transparent conductive oxide material, a metallic material, or a carbon-based material. The metallic material may be a metallic foam material. A non-limiting example of a metallic foam material may be a nickel foam. In various embodiments, the substrate may comprise or may consist of fluorine-doped tin oxide, nickel foam, or a carbon-based material. As an example, the substrate may be or may comprise a fluorine-doped tin oxide glass. In instances where the electrode is to be operable for smart window applications, the substrate may be transparent.

In various embodiments, the electrochromic energy storage device may be a smart window or an energy storage indicator.

The present disclosure also provides for a method of forming the electrochromic energy storage device described in various embodiments of the first aspect. The method may comprise contacting a substrate with an aqueous solution comprising a transition metal precursor and a tetradentate ligand precursor, adding a base to the aqueous solution in the presence of the substrate to form the first electrode, and electrically connecting the first electrode to the second electrode to form the electrochromic energy storage device. Advantageously, in the present method, the coordination between the transition metal and the tetradentrate ligand can be formed in the presence of the base. The substrate may be disposed substantially vertically or horizontally in the aqueous solution depending on the setup for contacting the substrate with the aqueous solution.

Embodiments and advantages described for the electrochromic energy storage device of the first aspect can be analogously valid for the present method of forming the electrochromic energy storage device subsequently described herein, and vice versa. As the various embodiments and advantages have already been described above and examples demonstrated herein, they shall not be iterated for brevity.

In various embodiments, the transition metal precursor may comprise a metal chloride, a metal nitrate, or a metal sulfate. In various embodiments, the transition metal precursor may comprise nickel, copper, cobalt, or iron. In various embodiments, the transition metal precursor may be or may comprise, as a non-limiting example, nickel chloride hexahydrate. Such transition metal precursors provide for the transition metal of the coordination polymer described in various embodiments of the first aspect.

In various embodiments, the tetradentate ligand may comprise or may consist of 1,2,4,5-benzenetetramine tetrahydrochloride. Such tetradentate ligand precursor provides for the tetradentate ligand of the coordination polymer described in various embodiments of the first aspect.

In various embodiments, adding the base to the aqueous solution may comprise mixing the aqueous solution for 2 hours to 4 hours, 2 hours to 6 hours, 4 hours to 6 hours, etc., with the base and the substrate present therein. As a non-limiting example, the base may be added to the aqueous solution and then stirred for 4 hours with the substrate present therein.

The present method, in various embodiments, may further comprise removing the first electrode from the aqueous solution, washing the first electrode with water before washing the first electrode with an alcohol, and drying the first electrode.

The present disclosure further provides for a method of forming an electrochromic energy storage film. Embodiments and advantages described for the electrochromic energy storage device of the first aspect and the method of forming the electrochromic energy storage device can be analogously valid for the present method of forming the electrochromic energy storage film subsequently described herein, and vice versa. As the various embodiments and advantages have already been described above and examples demonstrated herein, they shall not be iterated for brevity.

The film may comprise nanowires extending substantially perpendicular from a surface of the substrate as described above, wherein the nanowires may be formed of the coordination polymer already described above.

The method may comprise contacting a substrate with an aqueous solution comprising a transition metal precursor and a tetradentate ligand precursor, and adding a base to the aqueous solution in the presence of the substrate to form the electrochromic energy storage film.

In various embodiments already mentioned above, the transition metal precursor may comprise a metal chloride, a metal nitrate, or a metal sulfate. As a non-limiting example, the transition metal precursor may comprise nickel, copper, cobalt, or iron, one example of which may be nickel chloride hexahydrate as mentioned above.

In various embodiments already mentioned above, the tetradentate ligand may comprise or may consist of 1,2,4,5-benzenetetramine tetrahydrochloride.

In various embodiments already mentioned above, adding the base to the aqueous solution may comprise mixing the aqueous solution for 2 hours to 6 hours with the base and the substrate present therein.

In various embodiments, the present method may further comprise removing the electrochromic energy storage film from the aqueous solution, separating the electrochromic energy storage film from the substrate, washing the electrochromic energy storage film with water before washing with an alcohol, and drying the electrochromic energy storage film.

The word “substantially” does not exclude “completely” e.g. a composition which is “substantially free” from Y may be completely free from Y. Where necessary, the word “substantially” may be omitted from the definition of the invention.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance.

As used herein, the term “and/or” includes any and all combinations of one or more of the associated listed items.

Unless specified otherwise, the terms “comprising” and “comprise”, and grammatical variants thereof, are intended to represent “open” or “inclusive” language such that they include recited elements but also permit inclusion of additional, unrecited elements.

### EXAMPLES

The present disclosure relates to an electrochromic energy storage device having, as a non-limiting example, metallic nickel nodes and organic linkers (1,2,4,5-benzenetetramine, BTA), which may be grown on, as a non-limiting example, a transparent fluorine-doped tin oxide (FTO) conducting substrate via a scalable chemical bath deposition (CBD) method. The resultant NiBTA nanowires thin film exhibits superior performances for both electrochromic and energy storage functions.

Particularly, the uniform NiBTA nanowires film has been demonstrated, as a non-limiting example, to function as a smart energy storage indicator, for which the energy storage states may be visually identified in real time. The superior electrochromic and charge storage performances of the present NiBTA nanowires film render it potentially practical for use as electrode materials in various applications, such as but not limited to, electrochromic devices, energy storage cells and multifunctional smart window.

The present electrochromic energy storage device and its method of forming are described in further details, by way of non-limiting examples, as set forth below.

### Example 1A: Materials

1,2,4,5-benzenetetramine tetrahydrochloride (BTA-4HCl), nickel chloride hexahydrate (NiCl₂.6H₂O), potassium hydroxide (KOH) and concentrated aqueous ammonia (NIHI₄OH, ACS reagent, 28%-30% NH₃) were purchased from Sigma-Aldrich. Fluorine-doped tin oxide (FTO) coated transparent conductive glass was purchased from Zhuhai Kaivo Electronic Components Co., Ltd. All the chemicals were used as received. Deionized (DI) water (Milli-Q 18 MΩ, Millipore Corp.) was used for all experiments.

### Example 1B: Synthesis of NiBTA Film by Present Chemical Bath Deposition (CBD) Route

The pre-cleaned FTO glass was used as the transparent conductive substrate and the non-conductive side was covered with polyimide tape to prevent NiBTA deposition. The substrate was vertically supported on the wall of an open container bath. The solution for the CBD reaction was prepared by mixing a solution of 484.2 mg (2.04 mmol) of NiCl₂.6H₂O in 30 ml of DI water and a solution of 384 mg (1.35 mmol) of BTA.4HCi in 210 ml of water. Thereafter, 6.9 ml of concentrated NH₄OH was added to the mixture under a vigorous stirring. The reaction continued for 4 hours (hrs) under stirring at ambient conditions. Finally, the NiBTA films were obtained by removing the polyimide tape, and then washed with DI water, then ethyl alcohol, and dried under room temperature for 6 hrs.

### Example 1C: Solid-State Device Assembly

A solid-state electrochromic device was assembled by using the present NiBTA nanowires film as the electrochromic layer, sprayed TiO₂ nanoparticles film as the ion storage layer, 1 M KOH/polyvinyl alcohol (PVA, 10 wt %) as the solid electrolyte, and VHB clear mounting tape (4010, 3M) as the spacer, respectively. Ultimately, the solid-state electrochromic device was encapsulated using epoxy.

### Example 1D: Sample Characterization Methods

The crystalline structure of the NiBTA powder was investigated by x-ray diffraction (XRD, Bruker D8 Advance) technique with Cu-Kα-radiation (λ=1.541874 ∈). The spectral simulations were performed using TOPAS 6 Tutorial via Pawley fit method. Microstructure and morphology of NiBTA nanowires film on FTO glass were observed with a field emission scanning electron microscope (FESEM, JEOL 7600F) at 5.0 kV and an atomic force microscope (AFM, Asylum Research). Transmission electron microscopy (TEM) was performed on a JEOL JEM 2010 microscope operated at 200 kV accelerating voltage to observe the genuine microstructural information. X-ray pair distribution function (XPDF) data was collected at the I15-1 beainline at the Diamond Light Source, UK (λ=0.161669 ∈). Samples with small amount for the XPDF was loaded into a glass capillary with a diameter of 0.76 mm. Data on the sample, empty capillary and instrument data were collected. Background, container scattering, compton scattering, multiple scattering and absorption corrections were processed with the GudrunX program to achieve a Q=22 ∈⁻¹. Photoelectron spectroscopy (XPS) was carried out on PHI Quantara II Scan X-Ray Microscope with monochromatic Al Kα irradiation (1486.6 eV, beam size is 100 μm in diameter). To confirm the electrochromic and energy storage reaction mechanism, Raman and Fourier transform infrared spectroscopy (FTIR) were performed using a confocal Raman spectroscopy at 488 nm laser line (WITec, alpha300 SR) and a GX FTIR spectrometer (PerkinElmer Inc., Waltham, Mass., USA), respectively. Gas adsorption measurements were conducted on a Tristar II 3020 analyzer at 77 K. The specific surface area and pore volume were analyzed through a Brunauer-Emmett-Teller (BET) using N, gas and Barrett-Joyner-Halenda (BJH) analysis methods, respectively. Thermogravimetric analysis (TGA) was measured by a TA Q500 system.

### Example 1E: Electrochemical Characterization

The electrochemical and electrochromic measurements were performed using a three-electrode electrochemical configuration and 1 M KOH aqueous solution as the electrolyte. The NiBTA nanowires film on FTO glass served as the working electrode, Ag/AgCl worked as the reference electrode and a Pt foil with a size of 2.5×4 cm² was used as the counter electrode. Cyclic voltammetry (CV), square-wave potential and galvanostatic charge-discharge measurements were carried out on Solartron 1470E. CV curves with different scanning rates were measured between 0 V and 0.6 V versus (vs.) Ag/AgCl. The galvanostatic charge-discharge profiles with different current densities were measured from 0 to 0.5 V vs. Ag/AgCl. In situ electrochromic performance of the NiBTA nanowire films in response to different electrochemical conditions (CV, potential square-wave and galvanostatic charge-discharge) were evaluated through the combination of an ultraviolet-visible (UV-vis) spectrophotometer (SHIMADZU UV-3600) and Solartron 1470E. The transmission spectra of the NiBTA nanowire films over the wavelength range from 300 to 900 nm in the bleached and colored states were measured, respectively. The electrochemical impedance spectroscopy (EIS) measurements were carried out in the frequency range of 100 kHz to 0.01 Hz under open circuit voltage. The gravimetric capacity (C_{g}), and volumetric capacity (Cᵥ) and areal capacity (Cₐ) of NiBTA films on FTO substrates are calculated according to the following equation.

C_{g}=IΔt/3600M (1)

Cᵥ=IΔt/3600V (2)

Cₐ=IΔt/3600A (3)

where I (mA) and Δt (sec) denote the discharge current and time, respectively. M (g), V (cm³) and A (cm²) are the weight, volume and area of the NiBTA film, respectively. Typically, the loading mass of the NiBTA film used in the experiment is 0.02 mg cm⁻².

### Example 2: Discussion on Material Design, Fabrication and Structure Characterization

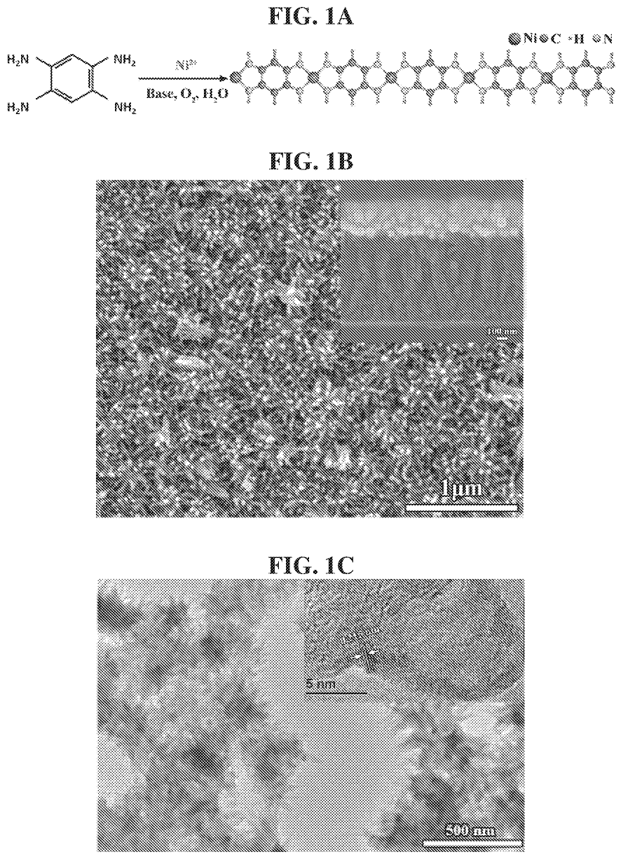

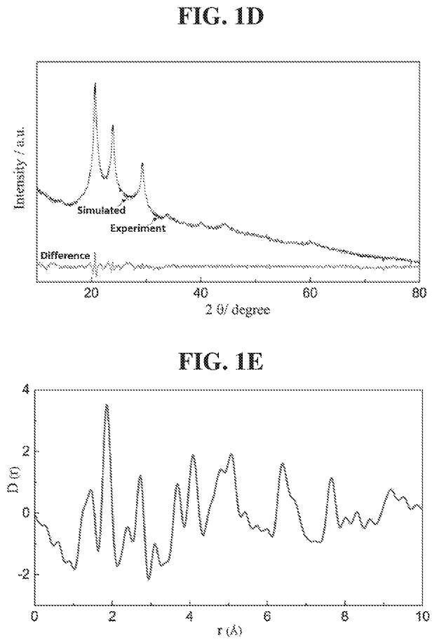

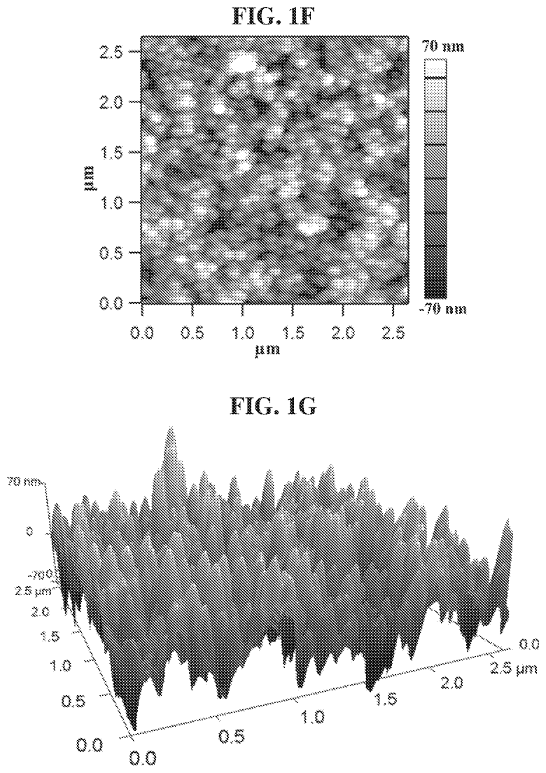

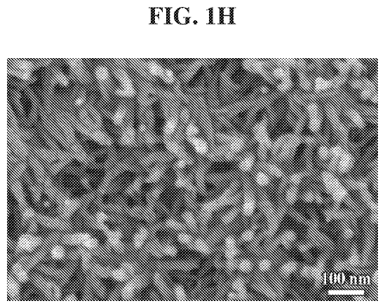

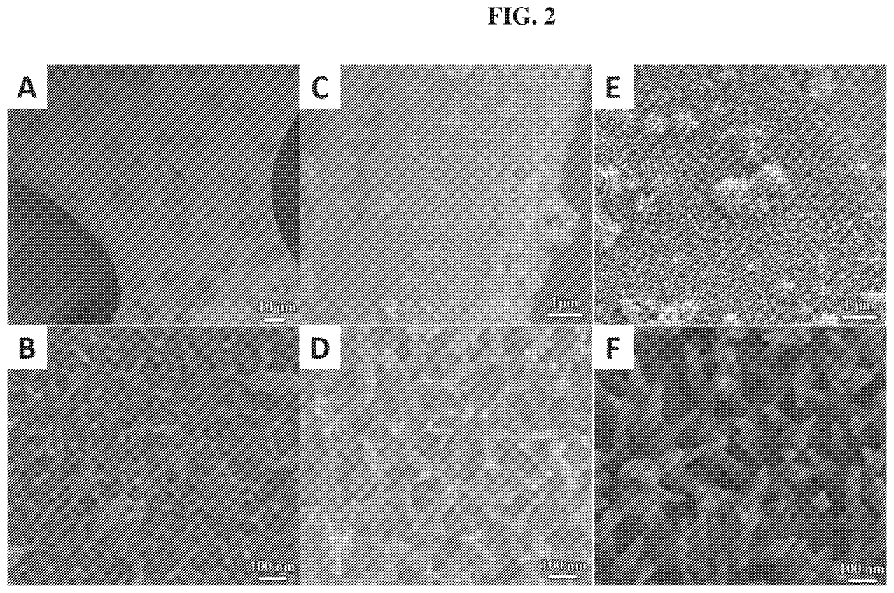

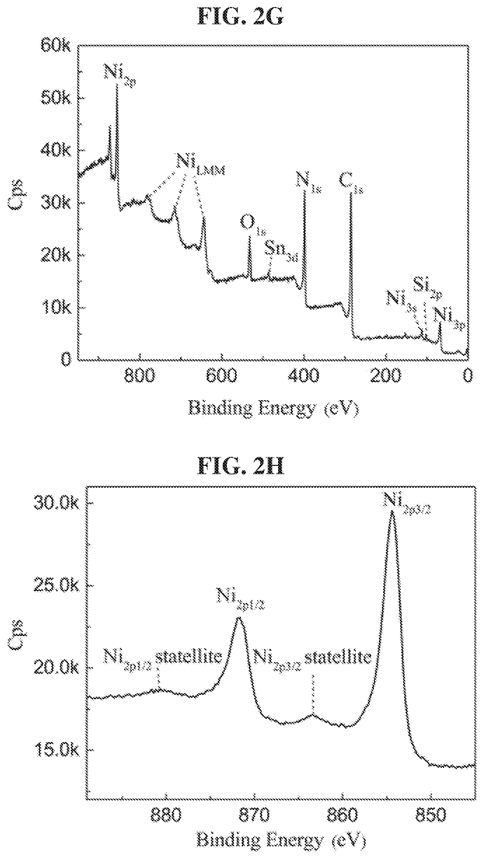

The BTA linker coordinates with d& metal species that prefer planar quadrilateral coordination geometry, which leads to the one dimensional π-d conjugated coordination polymer structure (FIG. 1A). This ultimately yields utrafine nanowires with diameter and length of about 20 nm and 280 nm (FIGS. 1B and 1H), respectively. The thickness of the NiBTA film is almost the same as the nanowire length (280 nm, inset of FIG. 1B). The NiBTA nanowires could be uniformly grown on the whole surface of FTO glass and almost vertically aligned to the substrate (FIGS. 1F and 1G). Moreover, the one dimensional NiBTA nanowires could be grown onto various substrates, including but not limited to, nickel foam, carbon fiber and textile (FIG. 2A to 2F), demonstrating versatility of the present synthesis method.

The structure of NiBTA nanowire was further investigated by high-resolution transmission electron microscopy (HRTEM) image (FIG. 1C). There are lattice-resolved fringes with spacing between adjacent lattice planes of 0.215 nm in the HRTEM image of NiBTA nanowire which confirmed the crystallographic features of the conjugated one dimensional CP (inset of FIG. 1C). X-ray photoelectron spectroscopy (XPS) of the NiBTA film revealed the presence of N, C, and Ni peaks in the sample while the O, Sn and Si peaks stem from the FTO glass substrate (FIG. 2G). The high-resolution Ni 2p spectra display peaks located at 854.4, 863.4, 871.7 and 880.7 eV (FIG. 2H), which could be attributed to the presence of Ni²⁺ in square planar geometry. The high-resolution N 1s spectrum indicated a single type of N atoms (FIG. 2I). XPS analysis proved that the NiBTA film was in a neutral state with absence of charge balance ions such as Cl⁻ and NH₄⁺. Powder x-ray diffraction (PXRD) measurement of NiBTA displayed a crystalline structure with three prominent peaks at 2θ=20.6°, 23.9°, and 29.3°, as well as some minor peaks at 2θ=14.4°, 33.8°, 40.1°, 44.2° and 60.1°, which correspond to the in-plane periodicity and long-range ordered stacking along c-axis (FIG. 1D).

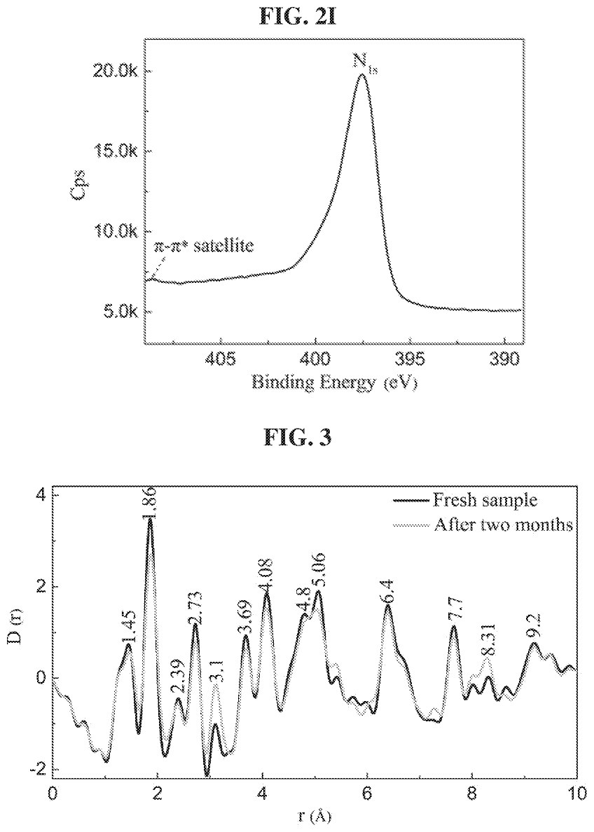

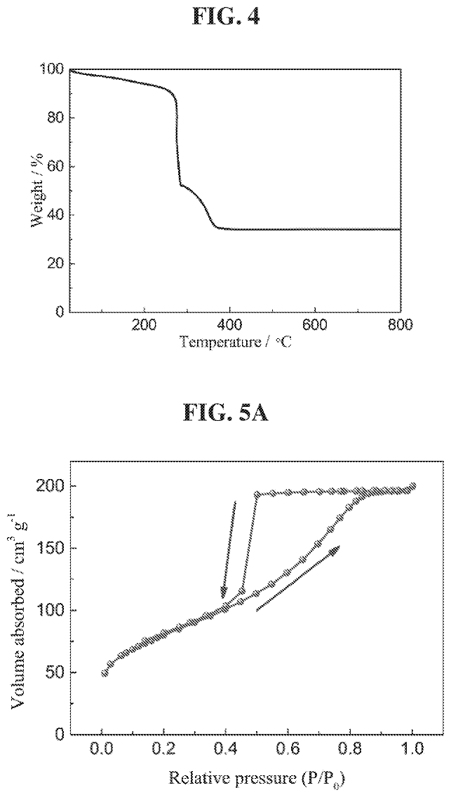

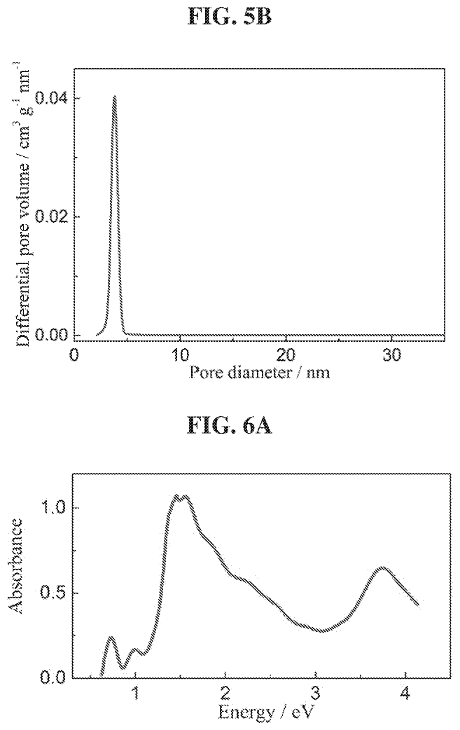

X-ray total scattering experiments were carried out using Diamond Light Source Synchrotron to further elucidate the real-space atomic structure of the conjugated coordination polymer. The corresponding X-ray pair distribution function (XPDF) was obtained by a Fourier transform of the corrected weighted total scattering to indicate interatomic distances within the sample. In general, XPDF is a useful experimental technique for analysing nanostructured materials because XPDF Lakes into account both Bragg and diffuse scatterings. Therefore, XPDF can provide information on short and medium range orders, leading to reliable quantitative models for determining atomic coordinates and unit cell structure. The XPDF produced can be thought of as a histogram of interatomic distances within the sample, by using a DFT model, the XPDF was assigned or contained peaks at approximately 1.45 Å, 1.86 Å, 2.73 Å and 7.7 Å (FIG. 1E), which corresponded to C—C/C—N, Ni—N, Ni—C and Ni—Ni pair correlations, respectively. At longer distances, the peaks could not be easily assigned to a single inter-atomic distance due to multiple overlapping contributions and correlations of similar distances. Additionally, the XPDF showed sharp peaks up to 10 Å indicating the presence of well-ordered coordination units in the one dimensional π-d conjugated CP. Moreover, no significant change in the XPDF was observed in NiBTA CP that was exposed to air for 2 months (FIG. 3), illustrating a good environmental stability of the one dimensional CP that was resistant to atmospheric corrosion. Thermogravimetric analysis (TGA) measurement was performed for freshly cleaned NiBTA powder (FIG. 4). The weight loss below 250° C. was attributed to dehydration of loosely bonded water, indicating the thermodynamic stability of NiBTA conjugated coordination polymer up to 250° C. The fast weight loss in the temperature range of 260-284° C. was assigned to the combustion of organic linkers. In the temperature range of 284-375° C., the sluggish weight loss was attributed to a combination of weight gain from the oxidation of nickel nodes into NiO and the weight loss from combustion of organic linkers. When the temperature was higher than 400° C., the organic linkers were completely removed and the nickel nodes were totally transformed to NiO. Moreover, the weight ratio of Ni in the TGA result was consistent with a chemical formula (NiN₄C₆H₄). The porosity of NiBTA one dimensional CP was investigated from the nitrogen sorption/desorption isotherms measured at 77 K (FIGS. 5A and 5B). The Brunauer-Emmett-Teller (BET) specific surface area was calculated to be 280.4 m²/g. NiBTA one dimensional CP exhibited a very steep desorption branch which was a characteristic feature of H2 loops. The steep desorption branch could be attributed to pore-blocking/percolation in a narrow range of pore necks, indicating a mesoporous structure, which was in good agreement with the pore size distribution in a narrow range from 2.5 to 4.7 nm with a pore volume of 0.3 cm³/g (FIG. 5B).

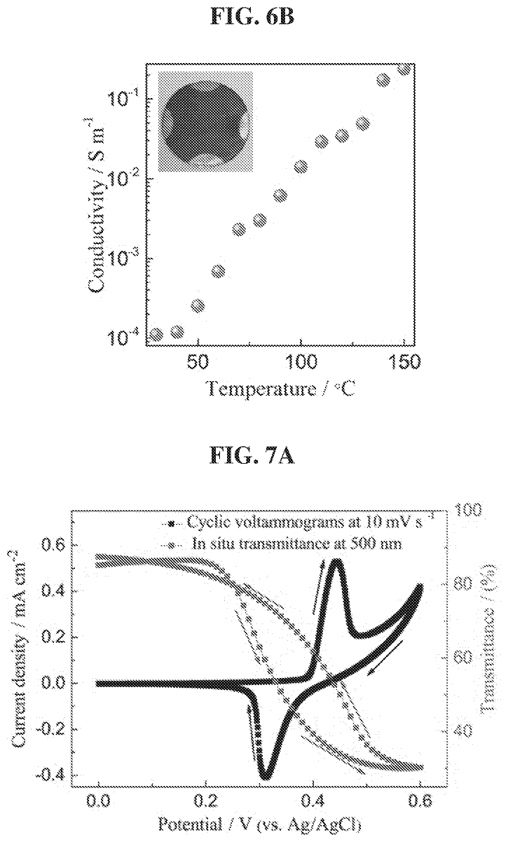

Electronic structure and electrical conductivity of the NiBTA one dimensional CP were further investigated. The electronic absorption spectroscopy showed a broad absorption from ultraviolet (UV) and visible (Vis) light to near infrared (NIR) region (FIG. 6A). The calculated optical band gap of NiBTA one dimensional CP was about 0.62 eV from the onset of the electronic absorption spectroscopy. The narrow band gap of NiBTA one dimensional CP could be attributed to the strong interaction of the π orbitals on the radical anionic BTA and the d orbitals of Ni²⁺, which resulted in a fully conjugated structure. The electrical conductivity was measured as a function of temperature through the Van Der Pauw method on a pressed pellet of NiBTA nanowires (FIG. 6B). To avoid interference from water or other solvents, the NiBTA nanowires were dried in vacuum at 80° C. for 24 hrs before measurement. In addition, four tiny gold electrodes were sputtered on the four corners of the pellet for contact purpose (inset of FIG. 6B). With numerous inter-grain boundaries and nanometer dimensions, the NiBTA nanowire based pellet still delivered an electrical conductivity of 1.1×10⁻⁴ S m⁻¹ at room temperature. The measured electrical conductivity had a sharp enhancement with increasing temperature, indicating the semiconductive property of NiBTA. There was a 2180 times enhancement of the conductivity (2.4×10⁻¹ S m⁻¹) when the temperature reached 150° C. The conductivity of NiBTA was lower compared to conductive CPs such as Ni-hexaaninobenzene (70±15 S m⁻¹) and Ni₃(2,3,6,7,10,11-hexaiminotriphenylene)₂ (5000 S m⁻¹), but much higher than semiconductive CP such as Cu-hexahydroxybenzene (7.3×10⁻⁶ S m⁻¹) and Cu[Ni(pyrazine-2,3-dithiolate)₂](1×10⁻⁶ S m⁻¹) This renders the present NiBTA economical for applications that do not require excessively high electrical conductivity but a reasonably improved level of electrical conductivity.

### Example 3: Electrochemical and Electrochromic Performance Evaluation

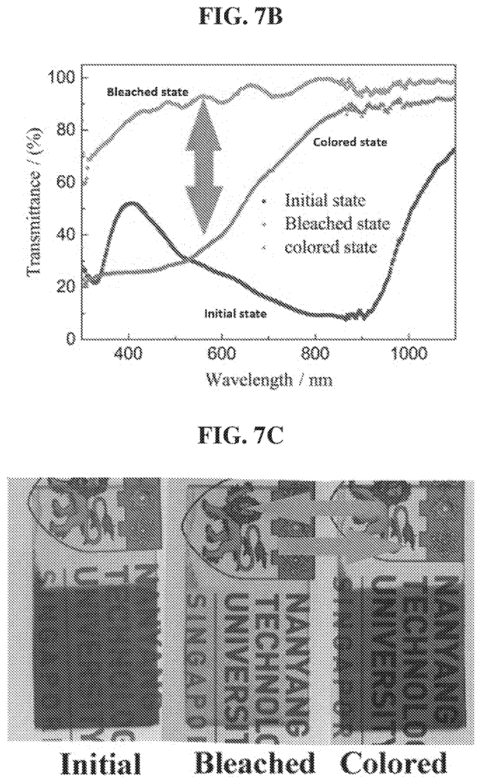

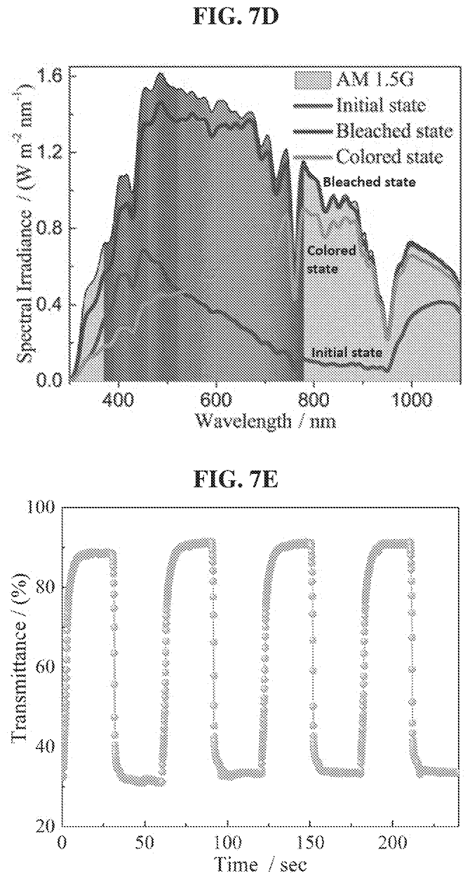

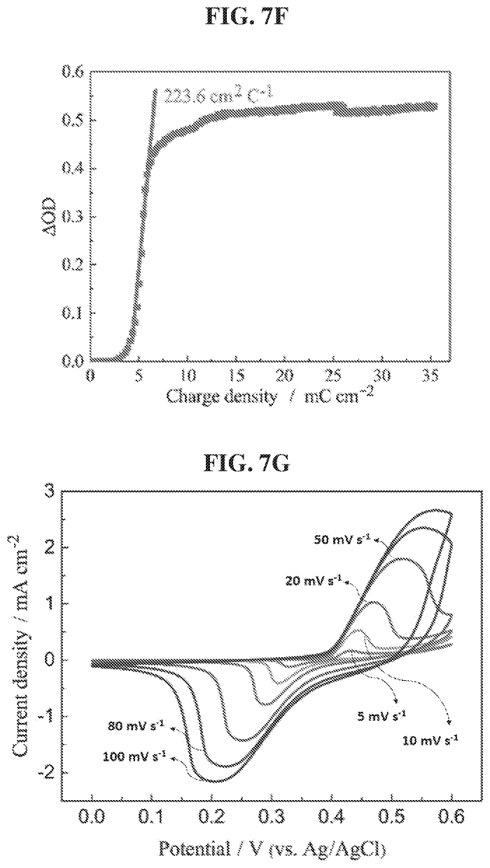

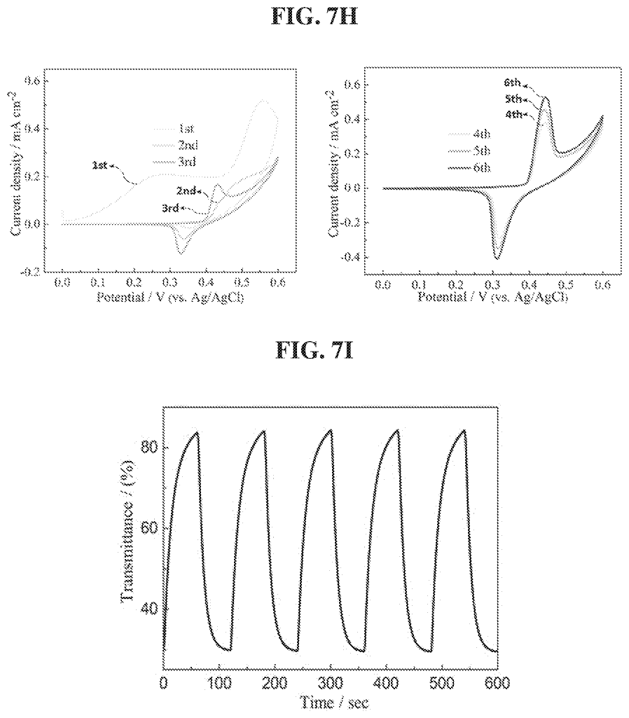

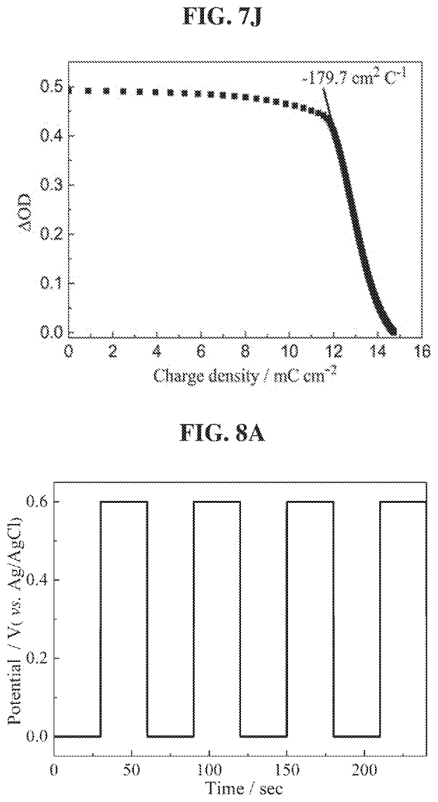

Encouraged by the higher surface area and higher conductivity of NiBTA one dimensional CP, the present NiBTA nanowires film possesses superior electrochemical and electrochromic performance at the same time. To demonstrate this, cyclic voltammetry (CV) and in situ dynamic transmittance spectrum at 500 nm were measured using a three-electrode spectroelectrochemical cell (NiBTA nanowires on conductive FTO substrate as working electrode, Ag/AgCl as reference electrode, Pt foil as counter electrode, and 1 M KOH aqueous solution as electrolyte). The CV curves starting from 1^{st} to 6^{th} cycle at 5 mV s⁻¹ and 10 mV s⁻¹ were respectively performed to illustrate the initial electrochemical processes in detail (FIG. 7H). It can be seen from the CV curves that the organic linkers and nickel nodes were oxidized at the first cycle (left plot in FIG. 7H). However, the oxidation reaction of organic links is not reversible. After 3 scanning cycles at 5 mV s⁻¹, most of organic linkers were oxidized and Ni nodes could undergo reversible oxidation-reduction reactions, thus, the original blue color almost disappeared. Meanwhile, the redox peak intensities of nickel nodes increase with increasing scanning cycles, indicating an activating process for the nickel nodes (right plot in FIG. 7H). The original blue color totally disappeared after 5^{th} cycle at 10 mV s⁻¹, indicating the activating process of nickel nodes has been accomplished. Then, the NiBTA nanowire film showed reversible color changes between brown color and transparent state, demonstrating the electrochromic processes occurred concurrent with the redox reaction. In order to investigate electrochemical and electrochromic processes simultaneously, the CV at a scan rate of 10 mV s⁻¹ and in situ dynamic transmittance spectra at 500 nm were measured (FIG. 7A). Over a potential range of 0 to 0.6 V vs. Ag/AgCl, the NiBTA nanowires on conductive FTO substrate exhibited one pair of pronounced redox peaks indicating a typical Faradaic behavior. The oxidative and reductive peaks at a scan rate of 10 mV s⁻¹ are respectively located at 0.444 and 0.312 V vs. Ag/AgCl, which were consistent with the Ni²⁺/Ni³⁺ redox couple observed in NiO and Ni(OH)₂ films, indicating the redox reaction was occuring at the nickel nodes of the NiBTA one dimensional CP. In situ optical spectrum of the NiBTA nanowires film revealed the transmittance at 500 nm was dynamically reduced when the potential was increased from 0 to 0.6 V vs. Ag/AgCl, and the transmittance was recovered to about its initial value when the potential was reversed back from 0.6 to 0 V vs. Ag/AgCl (grey dot line in FIG. 7A). Additionally, with increasing sweep rate from 5 to 100 mV s⁻¹, the current subsequently increased and the voltage separation between oxidative and reductive peaks widened due to an increased internal resistance of the electrode. However, the sharp redox reaction peaks were still maintained even at a high scan rate of 100 mV s⁻¹ (FIG. 7G), suggesting a fast charge transfer and low internal resistance in the NiBTA nanowires film. Moreover, the pronounced symmetric redox peaks illustrated excellent electrochemical reversibility of the NiBTA nanowires film.

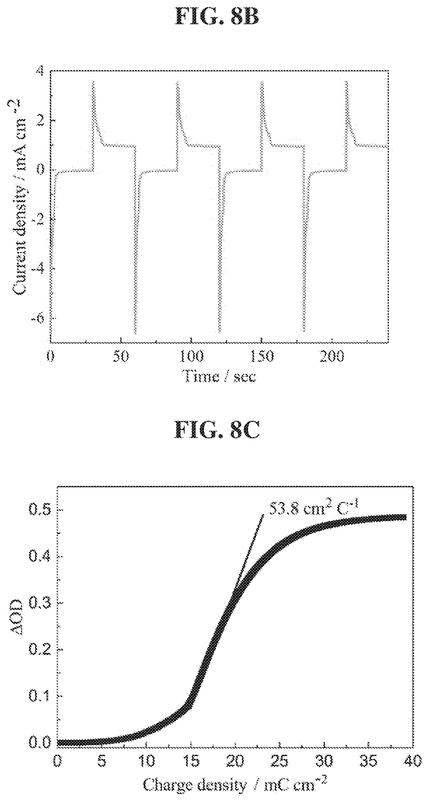

The electrochromic properties of the NiBTA nanowires film were investigated by measuring the broadband transmittance spectra from 300 nm to 1100 nm for its initial, colored and bleached states, respectively (FIG. 7B). The blue NiBTA nanowires film in the initial state was opaque in the broad visible (Vis) light to near infrared (NIR) regions, hence blocking most of the transmittance in the wavelength region from 450 nm to 1000 nm. After applying a potential of 0.6 V vs. Ag/AgCl on the NiBTA nanowire film, the film became transparent in the NIR region, but it was still opaque (having a brown colored state) in the ultraviolet (UV) and most Vis light regions (from 300 to 680 nm). When the applied potential was changed to 0 V vs. Ag/AgCl, the NiBTA nanowires film turned transparent (bleached state) in all the UV-Vis-NIR regions. Thus, this electrochemical reaction controlled state transformation could deliver an intriguing tri-state electrochromic phenomenon, with tunable transmittance covering the entire visible-light and partial UV and NIR (three bands) regions. The uniform color distribution and obvious color changes were also recorded by capturing the digital photographs in each state (FIG. 7C). The solar irradiation modulation of the NiBTA nanowires film was further studied by converting the optical transmittance spectra to the solar irradiance transmittance in the 300-1100 nm region (FIG. 7D). It was shown that the present NiBTA nanowires film could selectively modulate the dominating solar irradiance spectra. The NiBTA nanowires film in the initial state blocks most of the solar energy in the broadband region. 68.3%, 65.9%, and 90.4% of solar irradiance at 350 nm, 500 nm and 900 nm were blocked by blue NiBTA nanowires film in initial state. When the NiBTA nanowires film was switched to the bleached state, it was almost transparent to the solar irradiance spectra, only 24.98%, 10.01% and 7.14% of solar irradiance at 350 nm, 500 nm and 900 nm were blocked, respectively. On switching the NiBTA nanowires film to the colored state, most of the solar irradiance in UV and Vis regions were blocked, but a large proportion of the solar heat in the NIR region passed through the sample. At this state, 75.0% and 71.3% of the solar irradiance at 350 nm and 500 nm were respectively blocked, while only 14.78% of solar heat at 900 nm was blocked. Undoubtedly, this phenomenon is very promising in smart window applications. For example, the initial state of the film with blue color could simultaneously protect the occupant's privacy and reduce energy consumption of the building by resisting heat transmission from summer heat. On the other hand, during the bleached state, the high transmittance of the film to solar irradiance permits both sunlight and solar heat transmission, which effectively reduces the energy consumption for heating and lighting in winter. The occupants can also selectively modulate the coloration intensity of the smart window to protect their privacy while conserving energy costs for lighting and heating. By applying a square-wave potential between 0 and 0.6 V vs. Ag/AgCl to the present NiBTA nanowires film (having a size of 4 cm²) (FIG. 8A), the corresponding alternating current (FIG. 8B) and in situ transmittance spectra (FIG. 7E) could be obtained. The switching speed (time required to reach 90% of its full optical modulation) could be calculated from the in situ transmittance spectrum, which was t_{c}=1.8 s and t_{b}=5 s for coloring and bleaching, respectively. The switching times are comparable with the MOF-derived hierarchical-porous NiO@C films, but much faster than that of the conjugated conducting polymers. Optical memory is one of the considered parameters for electrochromic material, which refers to the transmittance change at open circuit. To evaluate the optical memory of the NiBTA nanowire film, the colored film was left in air without applied voltage and the transmittance was measured in real time (FIG. 8D). The transmittance degrades less than 16% after 2000 s, indicating a satisfactory optical memory of the NiBTA nanowire film. Coloration efficiency (CE), one of the key figure of merits of electrochromic materials, may be defined herein as the optical density (OD) changes per unit charge density (Q/A) inserted into/extracted out from the electrochromic materials during switching, which may be calculated based on following equation:

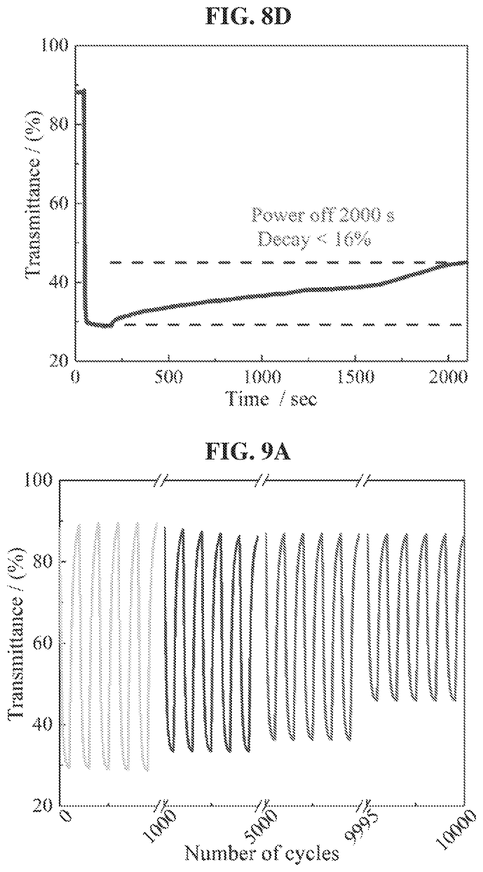

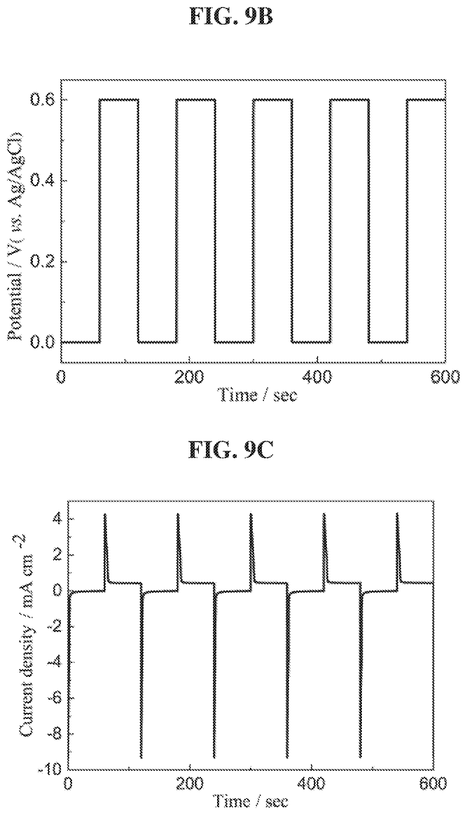

CE(λ)=ΔOD/ΔQ/A=log(T_{b}/T_{c})/ΔQ/A (4)

where T_{b} and T_{c} are the transmittance of the present NiBTA nanowires film in bleached and colored states, respectively. Therefore, the CE calculated from the slope of the linear fit region in OD at 500 nm versus Q/A plots is 223.6 cm² C⁻¹ for the coloration process (FIG. 7F). The CE value of coloration process is much higher than recently reported NiO and Ni(OH)₂ and most of the previous reported metal oxide electrochromic materials, which tend to be less than 100 cm² C⁻¹ in visible range. The transmittance changes versus cycle numbers at 500 nm was further measured to evaluate the electrochromic durability of NiBTA nanowire film (FIG. 9A). The NiBTA nanowire film sustained the optical modulation of about 90.8%, 86.3% and 67.9% of their initial value after subjected for 1000, 5000 and 10000 cycles, respectively, illustrating the excellent electrochromic durability.

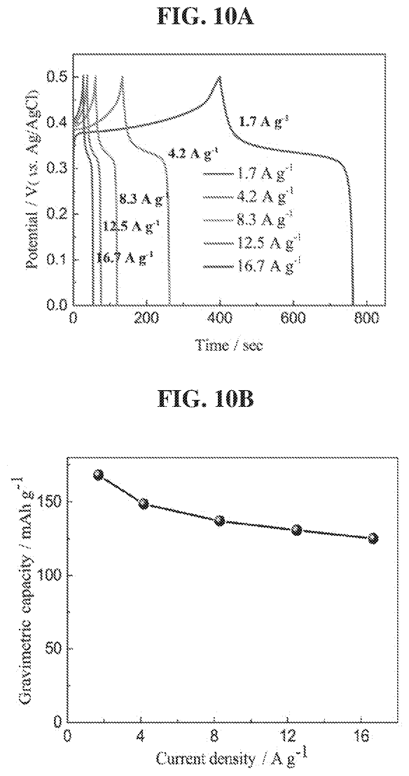

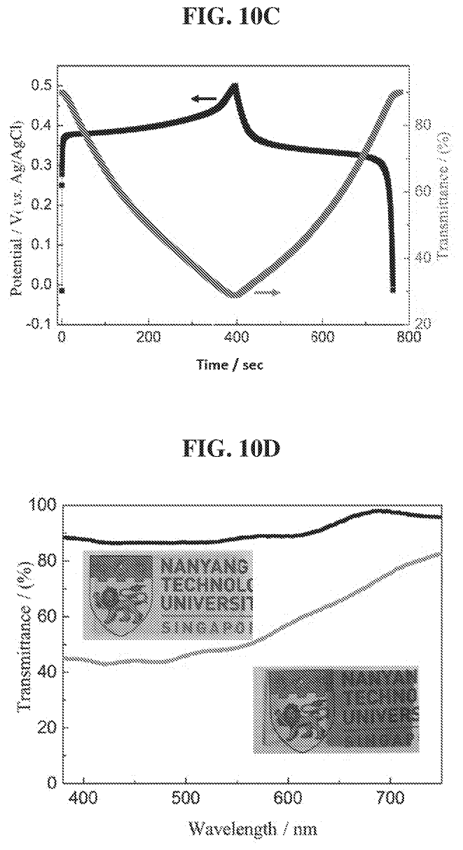

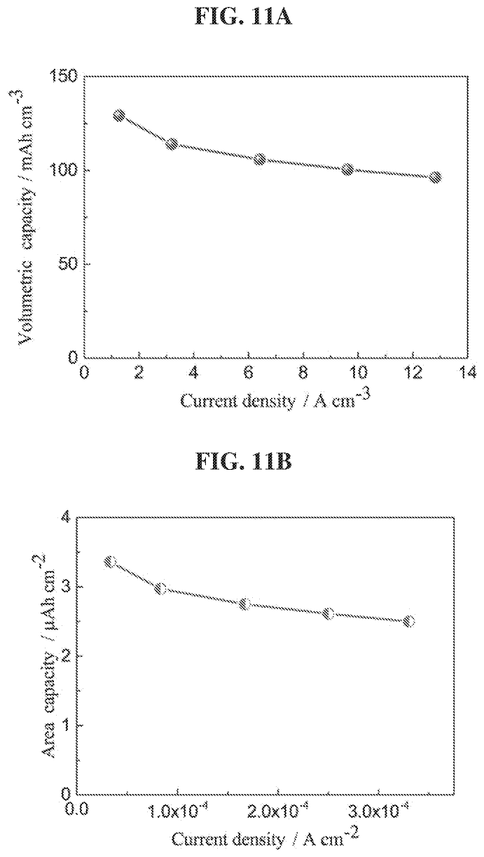

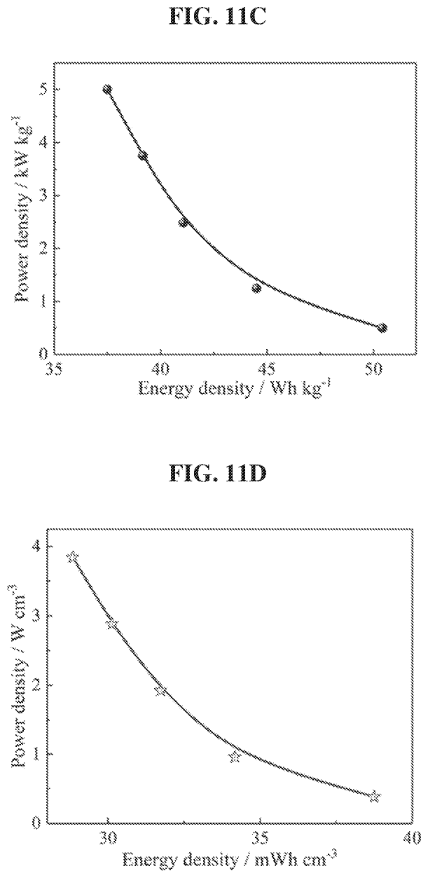

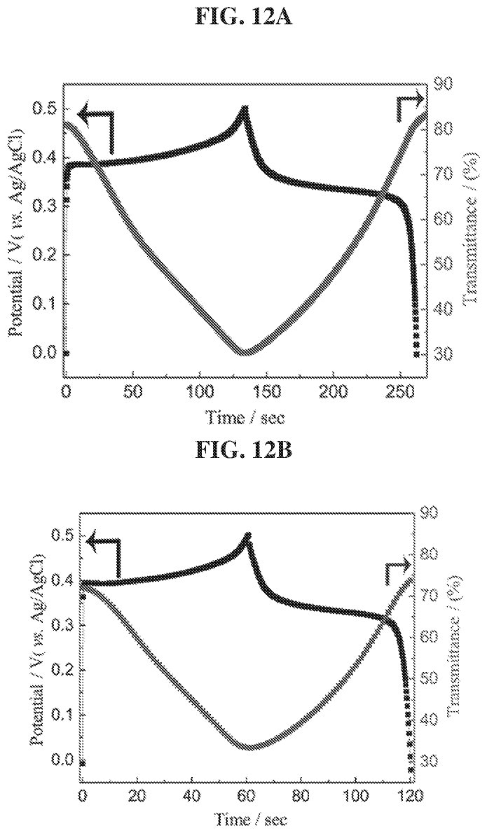

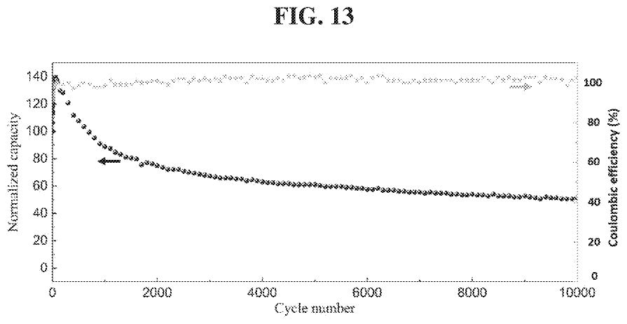

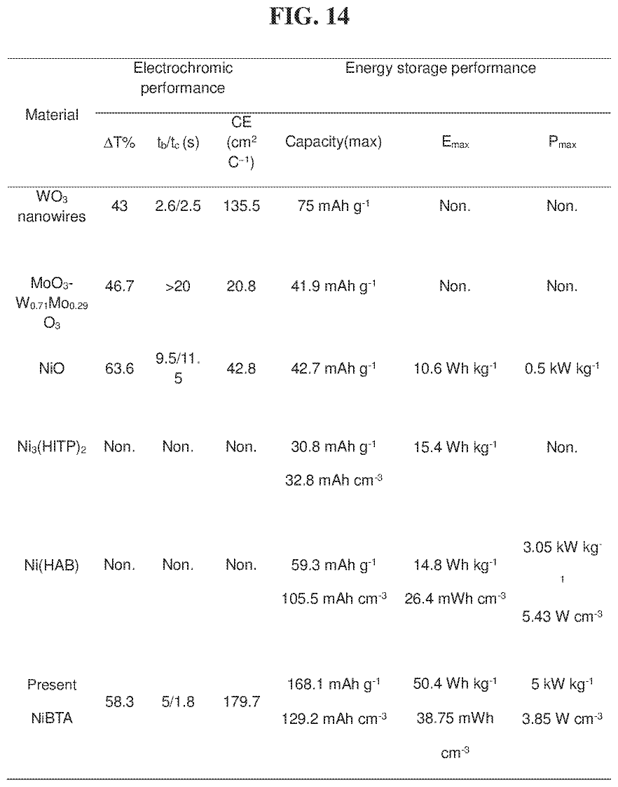

Further quantitative analysis of energy storage performance of the present NiBTA nanowires film on FTO glass in the same electrolyte showed battery-like energy storage behaviors. Even on the transparent FTO substrate with moderate conductivity (about 10 Ω/sq) and in the water based electrolyte (1 M KOH), the gravimetric and volumetric capacities of the present NiBTA CP film could achieve up to 168.1 mAh g⁻¹ and 129.2 mAh cm⁻³ at current densities of 1.7 A g⁻¹ and 1.28 A cm⁻³, respectively (FIG. 10B and FIG. 11A). The gravimetric capacity was 2.8 and 5.5 times higher than that of reported conductive CPs (30.8 and 59.3 mAh g⁻¹ at current density of 0.05 A g⁻¹ and scan rate of 0.2 mV s⁻¹, respectively). In addition, the present NiBTA nanowires film on FTO substrate exhibited an areal capacity of 3.36 μAh cm⁻² at a current density of 0.033 mA cm⁻² with a high transmittance of 90% at 500 nm (FIG. 11B). Moreover, the present NiBTA nanowires film also presented excellent rate capability, high gravimetric, volumetric and areal capacitites of 125 mAh g⁻¹, 96.2 mAh cm⁻³ and 2.5 μAh cm⁻² could be retained, even when the current density was increased 10 times, to 16.7 A g⁻¹, 12.8 A cm⁻³ and 0.3 mA cm⁻², respectively. (FIG. 10A to 10B, FIG. 11A to 11B, and FIG. 12A to 12B). The present NiBTA nanowires film delivers a gravimetric energy density of 37.5 Wh kg⁻¹ and a volumetric energy density of 28.8 mWh cm⁻³ at a high power density of 5 kW kg⁻¹ and 3.85 W cm₋₃, respectively (FIGS. 11C and 11D). The energy storage and electrochromic performances achieved by present NiBTA nanowires film are superior to other materials (FIG. 14). During these tests, the energy storage and electrochromic behaviors of the present NiBTA nanowires film came from the same electrochemical redox reaction (operating within 0˜0.6 V vs. Ag/AgCl for electrochromic tests, 0˜0.5V vs. Ag/AgCl for energy storage tests) within the same electrolyte system. The present NiBTA nanowires film therefore integrated both energy storage and electrochromic functions into a single device to develop an energy storage indicator from which the level of stored energy could be recognized visually from color changes at a fixed potential. In order to illustrate this attractive concept, the charge/discharge curves and corresponding in situ transmittance at 500 nm were measured (FIG. 10C). When the present NiBTA nanowires film was charged to a potential of 0.5 V at a current density of 1.7 A g₋₁, the color of the NiBTA nanowires film was changed from a transparent state to brown color. In the reverse process, the brown color faded away, and the film recovered its transparency when the discharge process was completed. Therefore, different storage states of the battery could be monitored by the dynamic color change. Even at high current densities of 4.2 and 8.3 A g₋₁, sufficient color switching was achieved by the present NiBTA nanowires film on FTO glass (FIGS. 12A and 12B), illustrating the superior charge carrier transport capability of the present NiBTA nanowires film. In this single bi-functional device, the consumed electrical energy of the electrochromic device could be fully re-utilized, which is a promising strategy for energy savings. Furthermore, the energy storage and electrochromic performances were well preserved with electrochemical cycling test, in which almost 100% coulombic efficiency was kept up to 10000 galvanostatic charge/discharge cycles, 89% and 51.4% of capacity was maintained after 1000 and 10000 galvanostatic charge/discharge cycles measured at a relatively high current density (12.5 A g₋₁) (FIG. 13). The optical modulation retained 66.4% at 500 nm when comparing the optical contrast before and after the 10000 galvanostatic charge/discharge cycles (FIG. 10D).

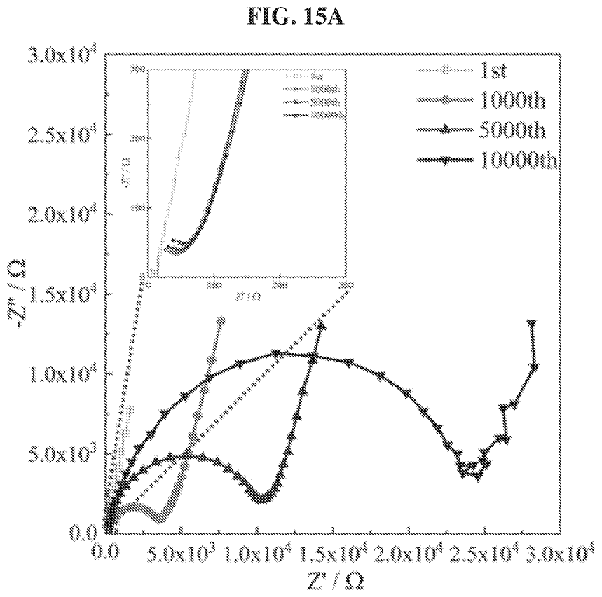

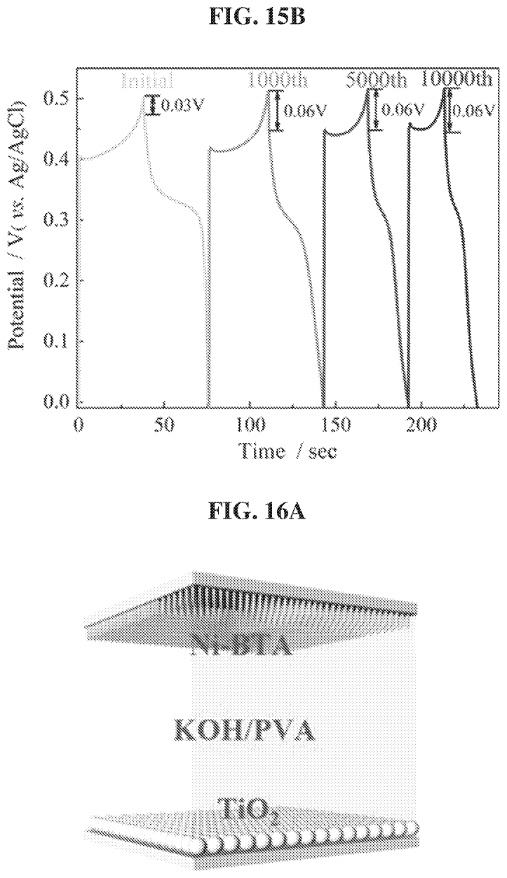

In order to demonstrate the degradation mechanism of the present NiBTA nanowires film during the electrochemical cycling, the electrochemical impedance and IR drop during galvanostatic charge/discharge were measured (FIGS. 15A and 15B). The high frequency region of electrochemical impedance spectroscopy and IR drop in discharge curves are characteristics of internal resistance, which consists of the resistance of the electrode/electrolyte interface, the separator, and the electrical contacts. The low frequency region of electrochemical impedance spectrum is associated with the charge-transfer resistance related to ion interfacial transfer, coupled with a double-layer capacitance at the interface. The internal resistance slightly increased after 1000 galvanostatic charge/discharge cycles, and then remained almost unchanged even for galvanostatic charge/discharge up to 10000 cycles. However, the charge-transfer resistance increased distinctly with more galvanostatic charge/discharge cycles carried out. Therefore, it is observable that degradation of the present NiBTA nanowires film during the galvanostatic charge/discharge cycling may be caused by increased charge-transfer resistance.

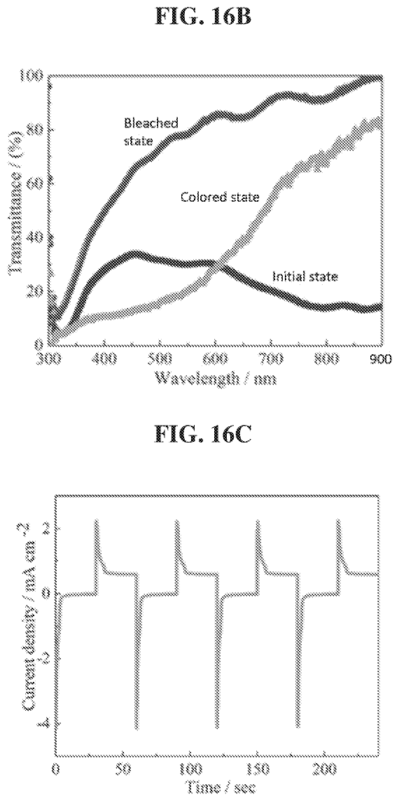

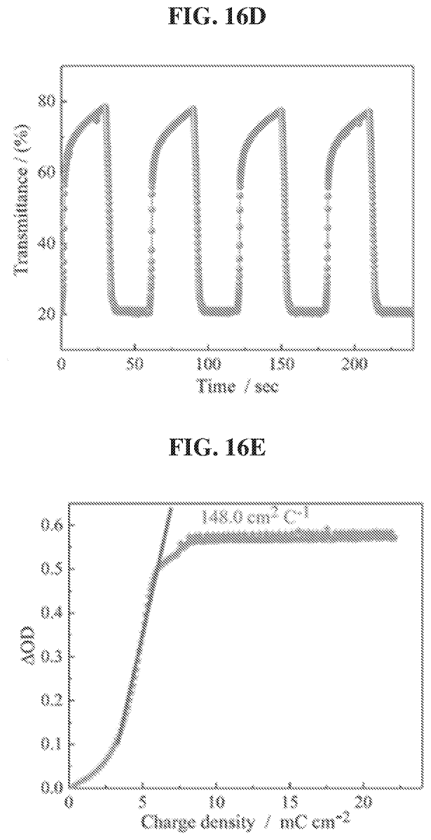

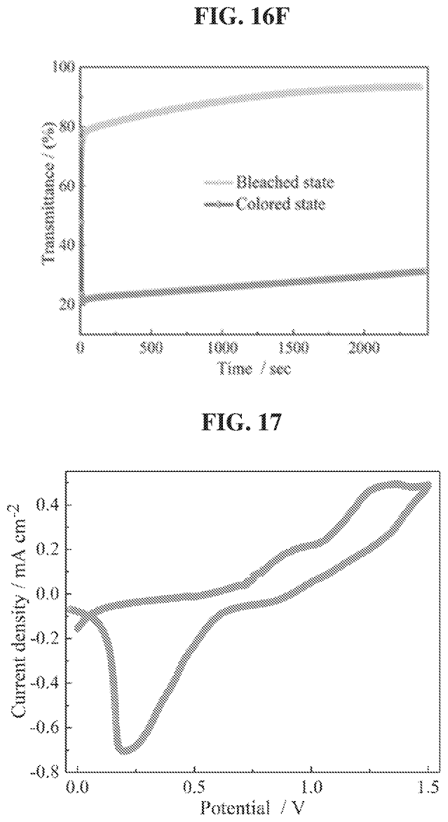

Further studies were carried out for a solid-state electrochromic device based on the present NiBTA nanowires film, sprayed TiO₂ nanoparticles film and KOH/polyvinyl alcohol (PVA) as the electrochromic layer, the ion storage layer and the solid electrolyte, respectively (FIG. 16A). The solid-state electrochromic device presented similar electrochromic process with the NiBTA nanowires film as TiO₂ is optical passive electrode material. After activated by CV (FIG. 17), the solid-state device exhibited high gravimetric and areal capacities of 125.2 mAh g₋₁ and 98 mAh m⁻² (calculated based on the CV curve), respectively. In addition, the solid-state device achieved large optical modulation in a broad visible light range and the value at 550 nm achieved up to 58% (FIG. 16B). Moreover, fast switching speed (4 s/13.2 s, FIG. 16D) and high CE (148 cm² C⁻¹, FIG. 16E) were achieved for coloring and bleaching processes, respectively. Furthermore, the solid-state device has a good bistability as the transmittance change less than 10% even open circuit for 2400 s at both colored and bleached states (FIG. 16F).

These excellent energy storage and electrochromic performances delivered from the present NiBTA nanowires film were attributed to the vertically aligned superfine one dimensional nanowires array structure, high porosity and the relatively high electrically conductivity of the NiBTA. The one dimensional nanowires array structure (i.e. vertically arranged nanowires) and porosity enabled abundant active sites for interactions of electrolyte and ions. The intrinsic narrow band gap of the present NiBTA nanowires provided sufficient conductive pathways for electrons transport within the electrode.

### Example 4: Summary

The present disclosure includes a one dimensional coordination polymers (CP) and a method of forming thereof. The electrochemical properties of the present CP may translate to optical modulation in multiple wavelength regimes for electrochromism and charge storage ability, simultaneously. The formed CP, in a unit device, enables dual functionality for use in smart windows and as an energy storage indicator.

The one dimensional CP may comprise a metal ion and 1,2,4,5-benzenetetramine (BTA), wherein the metal ion may be Ni²⁺, Cu²⁺, Co²⁺, Fe²⁺, preferably Ni²⁺, and wherein the one dimensional CP may be in the form of nanowires.

The present method of forming the one dimensional CP may include: (a) providing a substrate in an open bath container containing a solution of metal ion precursor and BTA, (b) adding concentrated base to the solution of metal ion precursor and BTA under stirring for 0.5-6 hrs to form the one dimensional CP film, and (c) wherein the metal ion may be Ni²⁺, Cu²⁺, Co²⁺, Fe²⁺, preferably Ni²⁺. Interestingly, the presently synthesized NiBTA nanowires could be vertically aligned on the substrates. The delocalization of electronic states on the one dimensional structure improves the conductivity of the coordination polymer. Additionally, the one dimensional vertically aligned structure facilitates the charge carrier transportation and increases the density of redox active centres because of spaces among the nanowires.

The metal ion precursors may include metal chloride, metal nitrate, metal sulfate, etc. The concentrated base may be ammonia, sodium hydroxide, potassium hydroxide, etc. The solution of metal ion precursor and BTA may be formed using a solvent, wherein the solvent may be alcohol, N,N-dimethylformamide, N-methyl pyrrolidone, water, and a mixture thereof.

The present disclosure also relates to an electrochemical optical modulator comprising the present CP. The electrochemical optical modulator may comprise a three-electrode electrochemical configuration, one of which is a working electrode. The working electrode may include or may be a film comprising the one dimensional CP (e.g. comprising Ni ions and BTA coated on a conductive substrate), wherein the film may exhibit a tri-state electrochromic properties, which includes (1) being opaque to broad visible light to NIR regions blocking most transmittance from 450 nm to 1000 nm, (2) being transparent in the NIR region but remains opaque (e.g. a colored state) in the ultraviolet and visible light regions (from 300 nm to 680 nm) when a potential of 0.6 V vs. Ag/AgCl is applied, (3) being transparent in all ultraviolet-visible light-infrared regions when a potential of 0 V vs. Ag/AgCl is applied, and wherein the film may simultaneously store charges when a potential is applied.

The present NiBTA CP coordinated polymer may be a one dimensional π-d conjugated CP in which 1,2,4,5-benzenetetramine (BTA) linkers and nickel (Ni) ions (as nickel based materials are, as demonstrated herein, useful for delivering electrochemical activity, especially for use in energy storage and in the field of electrochromic applications) increase the density of redox active centres and construct the conductive paths. Different from conventional CPs where the redox reactions are confined to the organic linkers, the redox reaction of the present CP (NiBTA) is centered on the nickel nodes, exhibiting exceptional electrochemical properties with applications in the fields of electrochromic and energy storage. Said differently, the redox reaction of the metal nodes, e.g. the nickel nodes, is dominant with the application of a potential in an appropriate electrolyte. In this instance, the electrochemical activity and stability arising from the metal nodes are superior over the electrochemical properties that may be provided by the organic linkers in conventional CPs. Moreover, NiBTA can be fabricated into a uniform thin film by a facile and scalable chemical bath deposition (CBD) method already described above. After growing on a transparent conductive FTO glass under a mild condition, the constructed one dimensional CP based film provides excellent performance on both electrochromic and energy storage applications, delivering a large optical modulation of 61.3% at 500 nm, a high gravimetric capacity of 168.1 mAh g⁻¹ at 1.7 A g⁻¹ a high volumetric capacitance of 129.2 mAh cm⁻³ (at 1.28 A cm⁻³), and excellent rate capability. All these performances are at least comparable or even surpass conventional energy storage devices based on existing CPs and carbon materials.

Further, the one dimensional conjugated coordination polymer based on the BTA organic linkers and nickel nodes developed herein demonstrated superior electrochromic and energy storage performances, as well as long term electrochemical stability in aqueous electrolytes. In particular, the NiBTA nanowires film grown on FfO glass shows a tri-state electrochromic phenomenon, large optical modulation, fast switching speed, high coloration efficiency, high gravimetric and volumetric capacities, all at the same time. Additionally, a smart energy storage indicator electrode has been demonstrated in which different storage states can be visually recognized in real time. The present CP material, which synchronously exhibits both electrochromic and energy storage functions, may also be used in applications for catalysis, sensing and electronics.

Advantages of the present CP include higher energy density with multiple functions, better coloration efficiency and stability, having tunable optical modulation in multiple wavelength regimes, and its method of making is non-toxic, scalable, and economically synthesizable using ambient temperatures and pressures.

Commercial applications of the present CP may include uses as electrochromics in smart windows, smart displays, camouflage and optical shielding, and optical sensing applications. Other commercial applications may include energy storage with color indicator as an integrated device, which allows users to monitor the state of energy consumption or level of remaining energy stored. The amount of energy stored can be used to trigger optical modulation.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. An electrochromic energy storage device comprising:
a first electrode and a second electrode disposed in an electrolyte;
wherein the first electrode comprises a coordination polymer, wherein the coordination polymer comprises a transition metal and a tetradentate ligand conjugated to the transition metal, wherein the transition metal and the tetradentate ligand render the first electrode operable to:
(i) store electrical energy and at the same time change from a first optical state to a second optical state upon electrical charging of the electrochromic energy storage device, and
(ii) release electrical energy stored therein and at the same time change from the second optical state to the first optical state upon electrical discharge of the electrochromic energy storage device.

2. The electrochromic energy storage device according to claim 1,
wherein the transition metal comprises nickel, copper, cobalt, or iron.

3. The electrochromic energy storage device according to claim 1, wherein the tetradentate ligand comprises 1,2,4,5-benzenetetramine.

4. The electrochromic energy storage device according to claim 1, wherein the first electrode comprises a substrate which the coordination polymer is disposed on.

5. The electrochromic energy storage device according to claim 4, wherein the coordination polymer is in the form of nanowires, wherein the nanowires extend substantially perpendicular from a surface of the substrate.

6. The electrochromic energy storage device according to claim 4, wherein the substrate comprises a transparent conductive oxide material, a metallic material, or a carbon-based material.

7. The electrochromic energy storage device according to claim 1, wherein the first optical state and the second optical state exhibit a difference in transmittance ranging from 40% to 60% for electromagnetic waves having a wavelength ranging from 400 nm to 600 nm.

8. The electrochromic energy storage device according to claim 1, wherein the first optical state and the second optical state exhibit a difference in transmittance ranging from 20% to 60% for electromagnetic waves having a wavelength ranging from 600 nm to 800 nm.

9. The electrochromic energy storage device according to claim 1, wherein the first optical state and the second optical state exhibit a difference in transmittance ranging from 10% to 20% for electromagnetic waves having a wavelength ranging from 800 nm to 1100 nm.

10. The electrochromic energy storage device according to claim 1, wherein the electrochromic energy storage device is a smart window or an energy storage indicator.

11. A method of forming the electrochromic energy storage device according to claim 1, the method comprising:
contacting a substrate with an aqueous solution comprising a transition metal precursor and a tetradentate ligand precursor;
adding a base to the aqueous solution in the presence of the substrate to form the first electrode; and
electrically connecting the first electrode to the second electrode to form the electrochromic energy storage device.

12. The method of claim 11, wherein the transition metal precursor comprises a metal chloride, a metal nitrate, or a metal sulfate.

13. The method of claim 11, wherein the tetradentate ligand comprises 1,2,4,5-benzenetetramine tetrahydrochloride.

14. The method of claim 11, wherein adding the base to the aqueous solution comprises mixing the aqueous solution for 2 hours to 6 hours with the base and the substrate present therein.

15. The method of claim 11, further comprising:
removing the first electrode from the aqueous solution;
washing the first electrode with water before washing the first electrode with an alcohol; and
drying the first electrode.

16. A method of forming an electrochromic energy storage film, the method comprising:
contacting a substrate with an aqueous solution comprising a transition metal precursor and a tetradentate ligand precursor; and
adding a base to the aqueous solution in the presence of the substrate to form the electrochromic energy storage film.

17. The method of claim 16, wherein the transition metal precursor comprises a metal chloride, a metal nitrate, or a metal sulfate.

18. The method of claim 16, wherein the tetradentate ligand comprises 1,2,4,5-benzenetetramine tetrahydrochloride.

19. The method of claim 16, wherein adding the base to the aqueous solution comprises mixing the aqueous solution for 2 hours to 6 hours with the base and the substrate present therein.

20. The electrochromic energy storage device according to claim 1, wherein the electrochromic energy storage device is operable as an optical modulator.
